(19) United States
(12) Patent Application Publication
(10) Pub. No.: US 2016/0048718 A1
(43) Pub. Date: Feb. 18, 2016

(54) ENHANCED KINEMATIC SIGNATURE AUTHENTICATION USING EMBEDDED FINGERPRINT IMAGE ARRAY

(71) Applicant: AMI Research & Development, LLC, Windham, NH (US)

(72) Inventors: John T. Apostolos, Lyndeborough, NH (US); William Mouyos, Windham, NH (US); Dwayne T. Jeffrey, Amherst, NH (US); Richard Guidorizzi, Fairfax, VA (US)

(21) Appl. No.: 14/460,441

(22) Filed: Aug. 15, 2014

(51) Int. Cl. G06K 9/00; H04N 5/225; G06F 3/041

(52) U.S. Cl. CPC G06K 9/00087; G06K 9/0004; G06F 3/0412; H04N 5/2258

(57) ABSTRACT

A writing instrument with multiple embedded image sensors. Partial fingerprint images are combined with kinematic sensors to verify or identify a user.

### STATEMENT REGARDING FEDERALLY SPONSORED RESEARCH

This invention was made with U.S. Government support under contract number FA8750-13-C-0270 awarded by the Defense Advanced Research Projects Agency (DARPA). The U.S. Government may have certain rights to this invention.

### BACKGROUND

1. Technical Field

This application relates in general to biometrics and in particular to a writing instrument that has multiple embedded fingerprint sensors. Partial fingerprint image data may be combined with other sensors such as kinematic sensors to verify a person's identity.

2. Background Information

Despite the advanced capabilities of magnetic stripe and chip-enabled debit and credit cards, fraud in transactions has not diminished. This problem may stem from an inability to completely authenticate the person in possession of the card at a Point-of-Sale (POS) terminal. While many such systems now capture an image of the person's signature electronically, typically no attempt is made to match the signature image against a database of valid signatures.

It is even less common to use the captured signature with other available biometric information.

Suitable biometrics for example, may include taking a fingerprint and/or photograph of the person's face. Sophisticated pattern recognition algorithms can then be used to augment the process with so-called “multiple factor” authorization.

Continuous improvements in electronic technology have made it possible to provide miniature sensors that can detect the patterns in a human fingerprint. Examples include optical scanners, electroluminescent pressure sensitive systems, and even “finger swipe” detectors that use a capacitance effect. These sensors have become quite inexpensive and are even now found on many smartphones.

In another instance, finger images can be detected using a sensor embedded in a pen. However, for this detector to work accurately, it is important to repeatedly place nearly the same portion of the finger on the sensor that was originally designated when a master image of the finger was taken. Various types of finger guide devices can improve the operation of such systems.

In another approach described in U.S. Pat. No. 6,925,565, a pen-based identity verification uses biometrics. At a Point-of-Sale terminal, a customer submits a digital “signature” for reference purposes—the “signature” being a fingerprint. The customer is then issued a transponder that links the customer to the customer account and to the reference digital signature. When the customer uses a point-of-sale terminal, an interrogator disposed at the point-of-sale terminal transmits a radio signal requesting identity verification. The transponder submits the stored data to the interrogator. Thereafter, when the customer uses a stylus to submit written data (a signature), a sensor in the stylus makes incidental capture of biometric data that enables the interrogator to further confirm customer identity.

It has also become quite routine to use electronic signature pads in connection with completing a financial transaction such as a credit or debit card transaction. The user presents their card information to a point-of-sale terminal which includes an electronic pen, a pressure sensitive touchscreen, or other device which can capture an image of the user's signature.

Similar equipment is also used in other contexts such as to control secure access to a building or other facility.

### SUMMARY

In a preferred embodiment, a writing instrument such as a pen is provided with multiple image sensors. The image sensors are mounted on or within different axial locations of the main body of the instrument. Relatively small, inexpensive fingerprint sensors may be displaced in different areas of the pen body, but typically concentrated near a location on the barrel where a user typically grasps the pen. Each sensor in the array detects a portion of the fingerprint of one or more fingers of a user. As long as at least some of the sensors make contact with some part of the fingers, then the preferred authentication algorithms may provide accurate user authentication. In one embodiment several sensors are preferred to be actively matched.

There is no apriori knowledge needed for exactly where the user will hold the pen from use to use. This potential difficulty is solved by using a image matching algorithm that is position or translation independent. For example, one such algorithm may be a Fourier transform-based algorithm.

In certain embodiments, a Neuromorphic Pattern Recognizer (NPR) algorithm operates on the multiple, partial fingerprint images picked up by the sensor array. The NPR algorithm generally uses physiological and psychophysical properties involving human perception and cognition. More particularly, the NPR performs a spatial frequency domain transform on the detected partial image data similar to that of holographic-based optical correlators. A preferred result is minimal degradation of even these partial images, and toleration of rotations out of the original image plane.

In still other embodiments, fingerprint image matching is combined with kinematic biometric matching. Such kinematic information may include a habitual gesture, such as a person's handwritten signature, and be provided by position and movement sensors such as one or more accelerometers. These additional sensors may be disposed within the same pen and activated at the same time the fingerprint images are detected. The acquired kinematic data is then compared against a library of signatures to further authenticate the user.

Although the pen can be used with any writing surface, even a piece of paper, in some arrangements the pen can be used with a touchscreen. In such an implementation, the touchscreen can be used to acquire the habitual kinematic data.

As a result, an authentication method and system may be based on two authentication modalities—a physiological “signature” provided by the fingerprint images, and “user gestures”, which are a kinematic behavioral pattern. The same user interaction with the pen can be used for detecting both the physiological and kinematic modalities.

Optional aspects of the matching method and system can be based on previously proven algorithms such as any suitable pattern recognition algorithm(s). However, in some embodiments, the image match result and kinematic gesture result can be optionally integrated at a higher level with known Neuromorphic Parallel Processing techniques that have functionality similar to that of the biological neuron, for a multimodal fusion algorithm. For example, fingerprint profiles may be combined with the outputs from other sensors such as the kinematic signature stylometry. These pattern recognition and/or fusion algorithms may be wholly or partially implemented in remote servers accessible via wireless network(s), or in local special purpose neuromorphic processors.

### BRIEF DESCRIPTION OF THE DRAWINGS

The description below refers to the accompanying drawings, of which:

FIG. 1 shows one embodiment of a writing instrument, such as a pen, having an embedded fingerprint image array.

FIG. 2 is a more detailed view of the image array and typical position of a person's fingers on the pen.

FIG. 3 is an example partial fingerprint image.

FIG. 4 is a high level block diagram of the electronic components of the pen and an associated authentication system.

FIG. 5 is an example expected separation of valid and invalid user detection.

FIG. 6 is a process flow for initial enrollment and later authentication.

FIG. 7 is another embodiment of the pen as used with a tablet computer.

FIG. 8 shows a kinematic matching algorithm in more detail.

FIG. 9 is a block diagram of a neuromorphic processor used for fusing the results of image and signature matching.

### DETAILED DESCRIPTION OF PREFERRED EMBODIMENTS

Described below are techniques for providing a writing instrument, such as a pen, with multiple fingerprint image sensors. The fingerprint images are provided as a user goes about their normal interaction with the device, such as while signing their name, or making other habitual gestures. The image data and other biometric sensor outputs provide information to verify that a valid user has possession of the pen. In this way, physiological finger image data is combined with kinematic habitual gestures, both detected using a single device.

The basic idea here is to provide an electronic pen, mouse, puck, handheld electronic input device, or other writing instrument with two or more image sensors. Each sensor is capable of picking up a partial image of a fingerprint. The multiple partial fingerprint images are then provided to a pattern recognizer. If the algorithms used by the pattern recognizer are orientation independent, as long as at least one sensor makes contact with some part of at least one fingerprint while a user is signing their name, then the pattern recognizer can provide accurate fingerprint matching. In a typical arrangement, having several sensors ensures contact with multiple portions of multiple fingers.

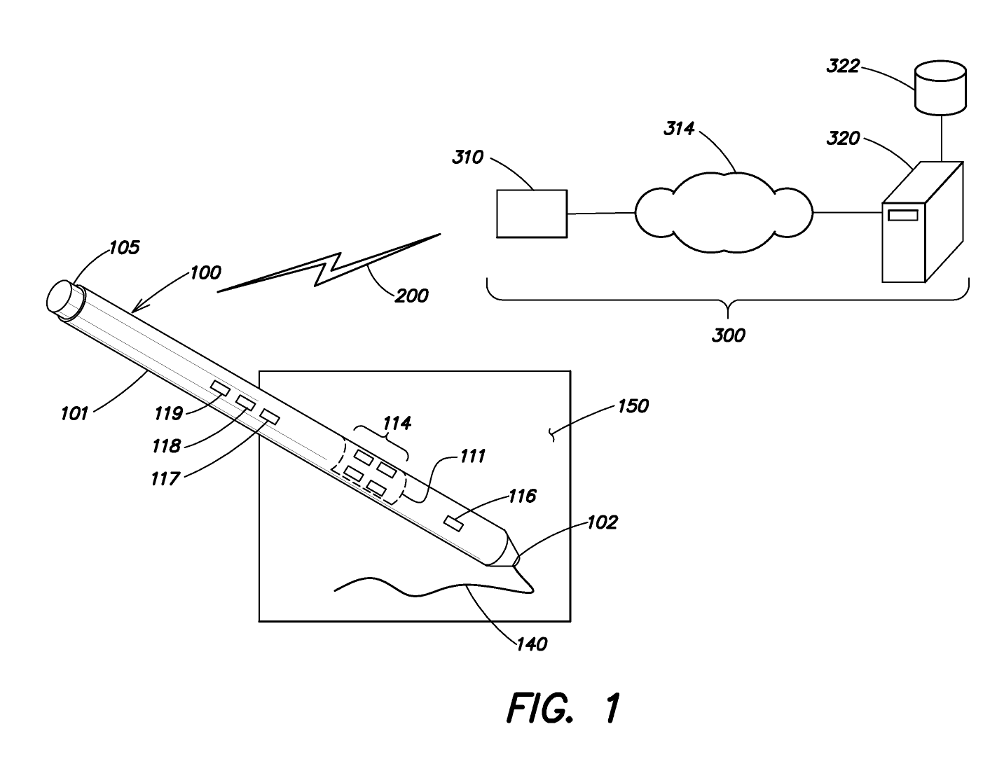

FIG. 1 illustrates one preferred embodiment. The example writing instrument is a pen 100 which includes a main body or barrel 101 and tip or nib 102. A user of the pen 100 may be signing their name or making some other habitual gesture 140 on a surface 150. In this implementation the surface 150 may simply be a piece of paper. The pen 100 may have or may not have other typical features of a pen such as a retractable ink cartridge 105 which are not of particular importance to the operation of the present systems and methods.

Of note is that a user grasps the pen 100 in a specific area 111, typically adjacent the lower portion of the barrel 101 near the tip 102. This area 111 has disposed adjacent to or on the surface of the barrel 101 a number of image sensors 114. The image sensors 114 are capable of forming at least partial image of the fingerprints from at least some of the fingers of the user.

The pen 100 may also include other biometric sensors, such as an accelerometer 116, for detecting the position and motion of the pen 100, as kinematic data.

Also included within the pen 100 are a number of other electronics. For example a wireless interface 117 permits the pen 100 to communicate detected fingerprint image and/or position and motion information over a wireless link 200 to other data processing systems such as an authentication system 300. The wireless interface 117 may be Bluetooth, WiFi, or some other convenient and inexpensive interface. Pen 100 typically also includes a processor 118 and memory and/or storage 119 to assist with fingerprint recognition and authentication systems and methods as described below.

The authentication system 300 may typically include a first component 310 which may for example be a wireless interface capable of receiving signals via the wireless link 200 from the pen 100. The interface 310 may communicate through other networks 314 to a server 320 and database 322. As described in more detail below, the authentication system 300 verifies who the user of the pen 100 is using the finger image data and kinematic signature data. It should be understood that in some arrangements one or more of the components of the authentication system 300 may be consolidated with other components. For example the processor 118 and memory 119 in the pen 100 may perform some or all of the user authentication methods described herein; in other embodiments the pen 100 may not even have a processor 118 or memory 119 and simply pass the detected fingerprint images and/or accelerometer signals over wireless link 200 to remotely locate data processing server 320 and database 322 for authentication.

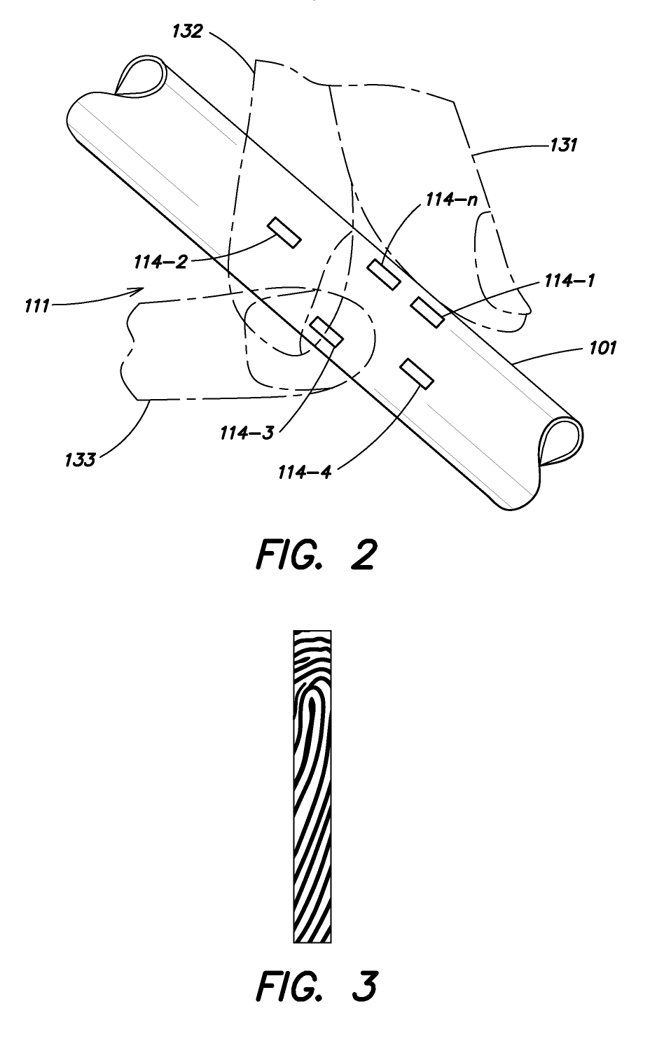

FIG. 2 is a more detailed view of the region 111 of the pen 100 adjacent where the barrel 102 is typically grasped. Here an array of individual image sensors 114-1, 114-2, 114-3, 114-4, . . . , 114-n are shown. The sensors 114 are dispersed on or near an outer surface of the barrel 102 oriented in different planes. In this example the user is grasping the barrel 102 with three fingers, including an index finger 131, middle finger 132, and thumb 133. In the particular position shown, at least one sensor such as sensor 114-1 is picking up a good image of a portion of the index fingerprint 131 but other sensors such as sensor 114-4 are in a position away from any of the fingers and therefore are not receiving any usable finger image data at all. Another sensor 114-2 is picking up a portion of the side of the middle finger 132, and sensor 114-3 is picking up a portion of the thumbprint. However neither sensor 114-2 or sensor 114-3 are axially aligned with the primary axis of the respective finger i.e. they are rotated with respect to vertical orientation of a fingerprint running axially with the major axis of the finger. It should therefore be appreciated that the various sensors 114 pick up different pieces of different fingers and that these images pieces may have different rotational orientations, may be partially occluded, and so forth. Note that in the illustrated arrangement, not all of the sensors lie in the same plane. For example, sensor 114-1 is on a portion of barrel 102 approximately 90° rotated with regard to sensor 114-3. It should also be understood that the user may not grasp the pen 100 in exactly the same way each time. Thus the particular image data pieces and/or relative rotations of the image pieces may often be different from use to use.

The image sensors 114 may be of various types. The typical sensor 114 may also provide only an image of a narrow strip of a fingerprint. For example, the narrow strip may be only 0.125 inches in height and/or width. FIG. 3 is one typical such partial fingerprint image. The partial fingerprint images may be provided at a resolution of approximate 500 dots per inch.

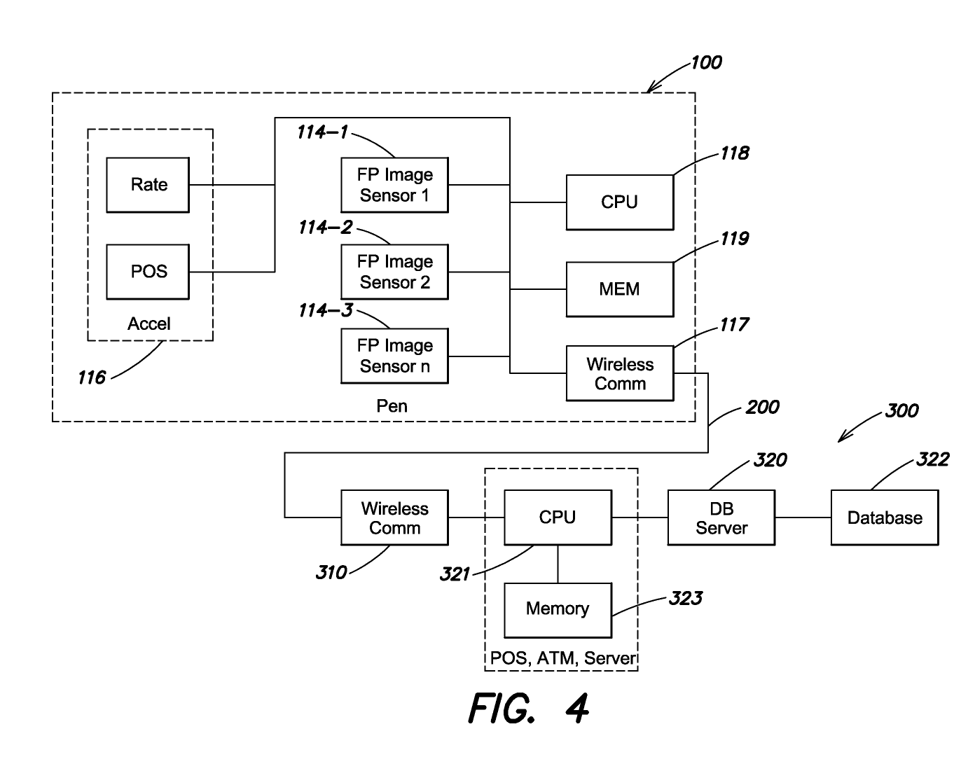

FIG. 4 is a high-level diagram of the electronic components of the pen 100 and authentication system 300. Here are shown processor 116 providing finger image and pen motion and position information to other components via a bus connection such as a central processor Unit (CPU) 118. The image sensors 114-1, 114-2, . . . , 114-N, provide respective image data. After an optional step of storage in the memory 119 and processing by the CPU 118 the image data and/or accelerometer outputs are provided via the wireless interface 117 over wireless link 200.

In one application of importance the pen 100 is used with authentication system 300 to determine whether or not the user can be authenticated, for example, in connection with a financial transaction. In this application, a wireless interface may form a part of a point-of-sale terminal, and the server 320 may be operated by a credit card processor or merchant. In other applications, the pen 100 and authentication system 300 may be used to control access to a secure facility.

The authentication system 300 therefore matches these individual image pieces against templates of different fingerprint pieces. The results from matching each individual image piece can then be fused together with the results of matching other image pieces. This can be done without a priori knowledge of exactly which fingerprint portion with exactly which orientation was detected.

The wireless communication interface 310 provides the image data to server 320 which may include a CPU 321, memory 323, and database server 322. In a preferred embodiment, system 300 performs fuses the various matched images and make a final decision as to whether the fused fingerprints are indicative of an authorized user.

An active kinematic gesture authentication algorithm may derive general biometric motion and compensate for variability in rate, direction, scale and rotation. It can be applied to any time series set of motions detected by the accelerometer 116. The preferred implementation is intended for personal signature authentication. A kinematic authentication algorithm then compares these and other features against known user characteristics and provides a probability of error.

The server 320 may also use other factors such as the detected habitual gesture data to further authenticate the user.

A particular useful approach to matching can use the neuromporhic pattern recognition (NPR) algorithms described in U.S. Pat. No. 8,401,297 to Apostolos et al. As long as at least one sensor makes contact with at least some part of at least one fingerprint, then the NPR algorithm should provide accurate authentication results. In a typical arrangement however it will be desired for several sensors to provide good contact with two or more portions of the fingers.

The NPR algorithms utilize physiological and psychophysical properties involving human perception and cognition. In a preferred embodiment, the NPR performs a spatial frequency domain transform on the image data which is similar to that of hologrammatic-based optical correlators. The result is minimal degradation of the results, even when only partial occluded images are available and toleration of rotations of the image planes.

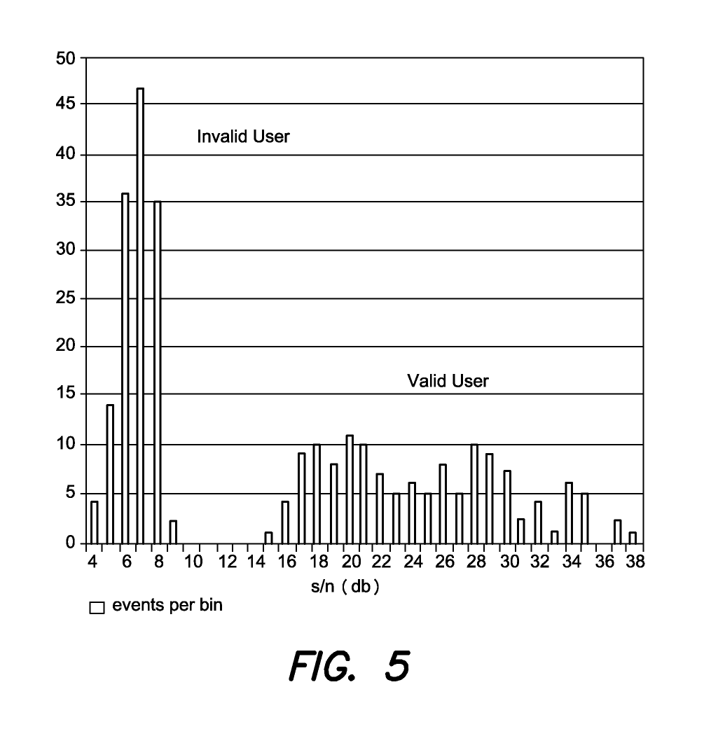

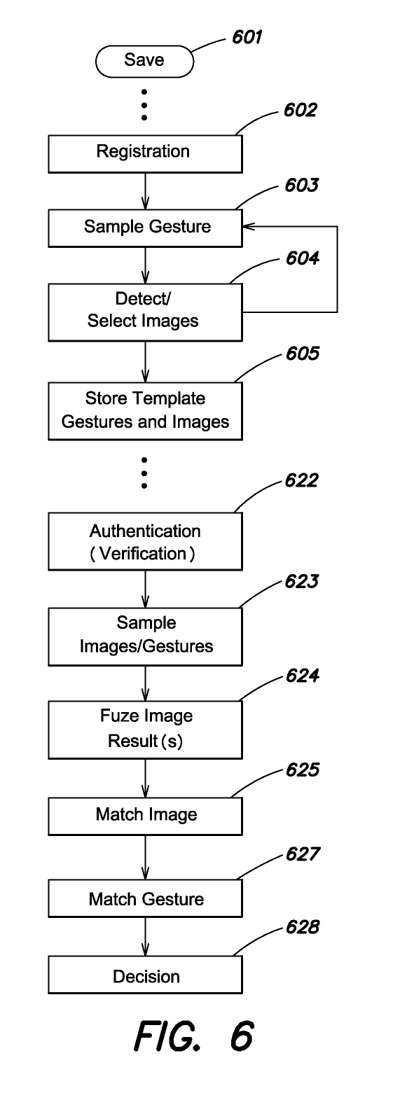

Results of recent experiments using a 0.125 inch fingerprint sensor in an analogous application are shown in FIG. 5. The results show excellent separation between valid users and invalid users. The experimental curves of probability of false acceptance and false detection are spaced far enough apart that the false rejection rate can be expected to be below 1 in 100,000.

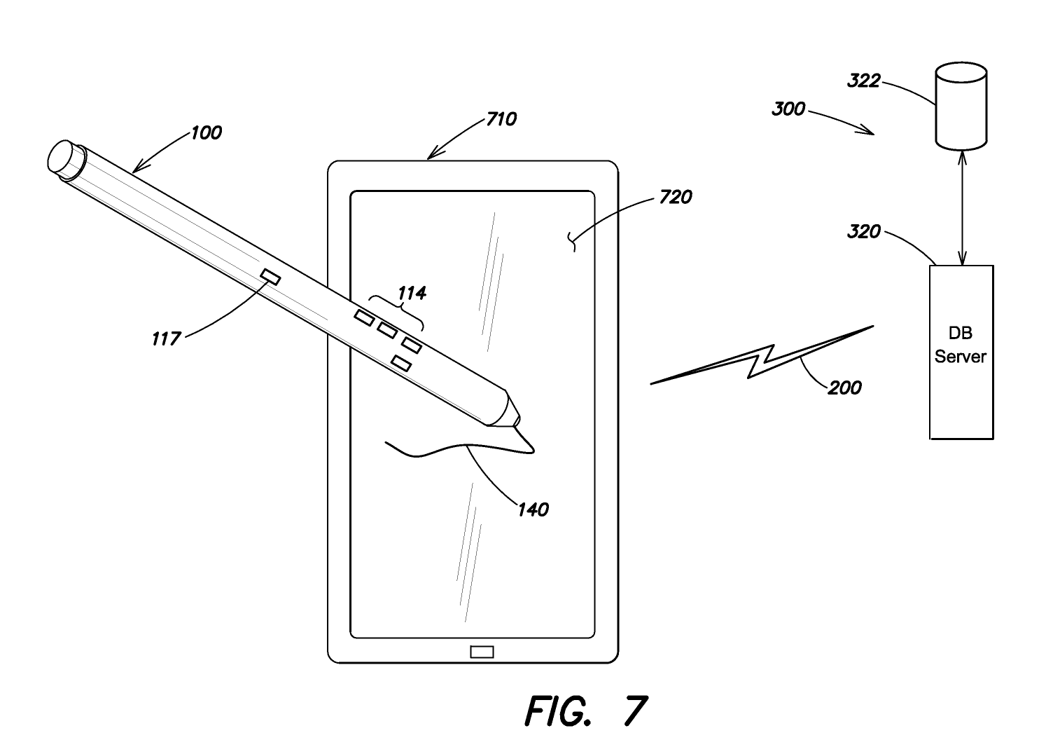

FIG. 6 shows a typical initial registration and subsequent authentication process using the pen 100. From a start state 601, the user may enter the registration process 602. Here, the user is known to be authorized. Fingerprint image information associated with the authorized user and kinematic information associated with that user's habitual gestures is collected. In a typical step 603, the user is prompted to make a gesture with the pen such as using the pen 100 to sign their name. In this stage, identified by both steps 603 and 604, the habitual gesture is also sensed by the accelerometer 116 at the same time that the fingerprint data is collected by image sensors 114. Steps 603 and 604 maybe iteratively performed to sample multiple data sets from a single user. In one alternate arrangement, fingerprints may not be initially detected from the pen itself but may also be provided from other sources such as a separate full fingerprint reader or retrieval from an existing fingerprint image database. If the pen 100 is used, the user may be asked to hold the pen in different orientations at different angles to provide more robust fingerprint image data sets.

In any event, the partial fingerprint image data is synthesized and stored as image templates for both the gesture and the fingerprint images in state 605. These templates may then be stored in database 327. It is preferred that the partial fingerprint image templates be non-reversible for security purposes. For example, it is preferable that a full fingerprint cannot be completely reconstructed from the image templates only.

At some later time a verification mode is entered in state 622. Here, it is not known whether the user is authorized or not. In state 623, fingerprint images and gestures are sampled from the pen 100. The data received from the various sensors 114 and accelerometer 116 are matched against the templates previously collected for the purported user in the registration process.

The results from individual image sensor matching may then be matched in step 624. In state 625 image data is matched against previously stored image data collected from authorized users. In state 627, the detected kinematic habitual gesture information is matched against the gesture templates previously collected. The result of matching the images and results of matching the gestures can be used in a decision process 628. The decision process 628 may weight the image data and the kinematic result equally, or weight them differently, or combine the information in various ways.

It should be understood that the matching processes can be used for both user identification as well as user verification. A user identification process begins with the system having no information as to who the user purports to be. Identification therefore may require matching fingerprint images and gestures against a library of many millions of templates. Verification is a somewhat simpler task, as the system starts with information as to who the user claims to be (such as in a point of sale application).

FIG. 7 illustrates an alternate embodiment where kinematic gesture data is acquired through a touchscreen device. Here the pen 100 may only have image sensors 114 embedded therein and may not use or may not have an accelerometer. The pen 100 is instead being used with a device such as a tablet 710 or smart phone that has a touch sensitive screen 720. The habitual gesture 140 is detected via touch sensors embedded in the device 710. The image data received from sensors 114 is passed via wireless interface 117 over link 200 as before. The link 200 may merely be between the pen 100 and tablet 710, with the tablet than performing the pattern recognition algorithms. Alternatively, one or more of the image data and habitual gesture data may be passed via wireless link 200 to the remote server 320 and database 322 to perform the algorithms described herein.

The touchscreen device 720 may use a projected capacitance (pro-cap) grid structure where an array of electrodes provide multiple touch points. The array electrodes may be transparent direct current (DC) conductors. In the typical device 720, a protective cover glass lens is laminated to the touch sensitive array.

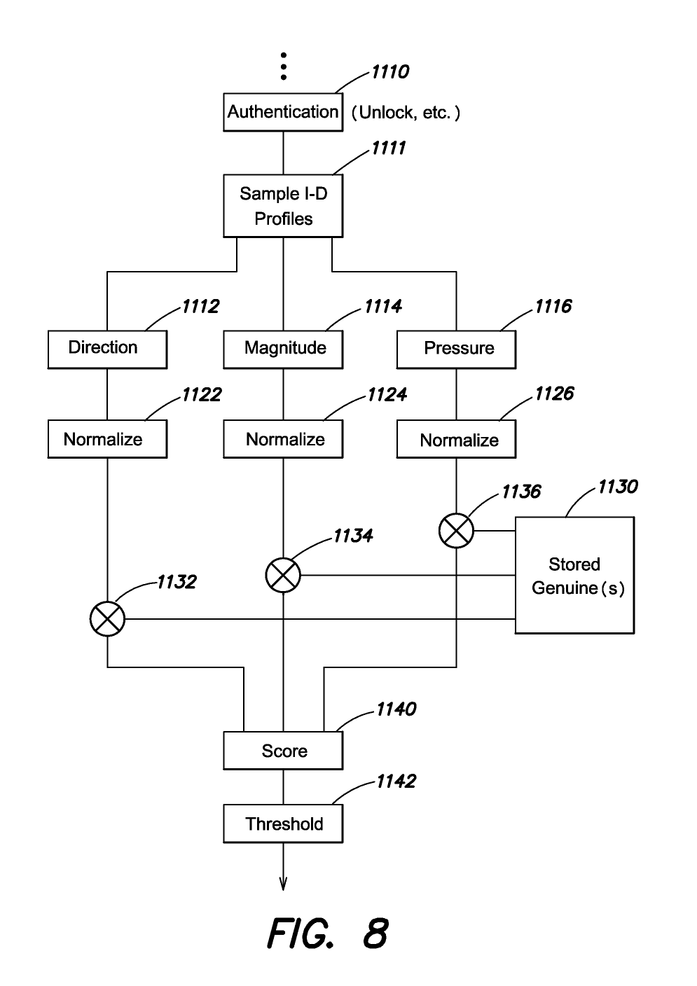

A detailed functional block diagram of a suitable kinematic gesture authentication algorithm used in step 627 is shown in more detail in FIG. 8. The input to the algorithm includes two (2) or more reference time series point sets (previously stored as the genuine signatures templates in state 605) and an unknown time series set detected from a present user of the pen. The algorithm may use raw reference data sets, and does not require training. The algorithm performs compensation for scaling and rotation on each of the point sets, and then compares the individual reference sets to the unknown producing an error value for each. The errors are combined into a single value which is compared to a standard deviation threshold for the known references, which produces a true/false match.

As shown in FIG. 8, a state 1110 is entered in which authentication of a current user of the device 110 is desired using the habitual gesture (kinematic) algorithm. This may be as part of an authentication sequence, building access request or some other state where authentication of the user of the pen is needed. A next step 1111 is entered in which samples of the kinematic gestures are obtained from the accelerometer 116 already described above. The profiles are then submitted to direction 1112, magnitude 1114, and pressure 1116 processing.

More particularly, step 1111 extracts features from the set of biometric point measurements. The direction component is isolated at state 1112 from each successive pair of points by using the arctangent of deltaX and deltaY resulting in a value within the range of −PI to +PI. This results in the direction component being normalized 1122 to within a range of 2*PI.

The magnitude component is extracted in state 1114 by computing the Euclidian distance of deltaX, deltaY and dividing by the sample rate to normalize it at state 1126. There may be other measurement values associated with each point such as pressure 1116, which is also extracted and normalized 1126.

The set of extracted, normalized feature values are then input to a comparison algorithm such as Dynamic Time Warping (DTW) or Hidden Markov Model for matching (1132, 1134, 1136) against a set of known genuine signature patterns 1130 for identification.

For signature verification, the normalized points are derived from a set of library data sets which are compared to another normalized set to determine a genuine set from a forgery. The purpose of normalization 1112, 1114, 1116 is to standardize the biometric signature data point comparison. Prior to normalization, the features are extracted from each pair of successive x, y points for magnitude 1114 and direction 1112. The magnitude value may be normalized as a fraction between 0.0 to 1.0 using the range of maximum and minimum as a denominator. The direction value may be computed as an arctangent in radians which is then normalized between 0.0 to 1.0. Other variations may include normalization of the swipe dynamics such as angle and pressure. The second order values for rate and direction may also be computed and normalized. The first order direction component isolates from scaling. A second order direction component will make it possible to make the data independent of orientation and rotation.

To perform the signature pair comparison, a DTW N×M matrix may be generated by using the absolute difference between each corresponding point from the reference and one point from the unknown. The matrix starts at a lower left corner (0,0) and ends at the upper right corner. Once the DTW matrix is computed, a backtrace can be performed starting at the matrix upper right corner position and back-following the lowest value at each adjacent position (left, down or diagonal). Each back-position represents the index of matching position pairs in the two original point sets. The average of the absolute differences of each matching position pair is computed using the weighted recombination of the normalized features. This is a single value indicating a score 1140 as an aggregate amount of error between the signature pairs.

The range of each error score is analyzed and a precomputed threshold 1142 is used to determine the probability of an unknown signature being either a genuine or an outlier. The threshold value is determined by computing error values of genuine signatures against a mixed set of genuine signatures and forgeries. The error values are used to determine a receiver operating characteristic (ROC) curve which represents a probability of acceptance or rejection.

As mentioned briefly above in connection with step 628, the user is authenticated by exploiting both their (1) habitual gestures along with (2) the epidermal characteristics of their finger images.

As one example, the Neuromorphic Parallel Recognition (NPR) technology, such as that described in U.S. Pat. No. 8,401,297 incorporated by reference herein, may be used. Processing may be distributed at a network server 320 level to fuse these different biometric modalities and provide another level of authentication fidelity to improve system performance. The aforementioned NPR technology for multimodal fusion, specifically a fast neural emulator, can also be a hardware building block for a neuromorphic-based processor system. These mixed-mode analog/digital processors are fast neural emulators which convolve the synaptic weights with sensory data from the first layer, the image processor layer, to provide macro level neuron functionality. The fast neural emulator creates virtual neurons that enable unlimited connectivity and reprogrammability from one layer to another. The synaptic weights are stored in memory and output spikes are routed between layers.

Processing, identification and validation functionality may reside on the pen 100 as much as possible. In order to accommodate potential commercial platform microprocessor and memory constraints, a more flexible architecture may allow the entire chain of pattern recognition and active authentication to be accomplished by the pen 100. This architecture also minimizes the security level of software in the pen.

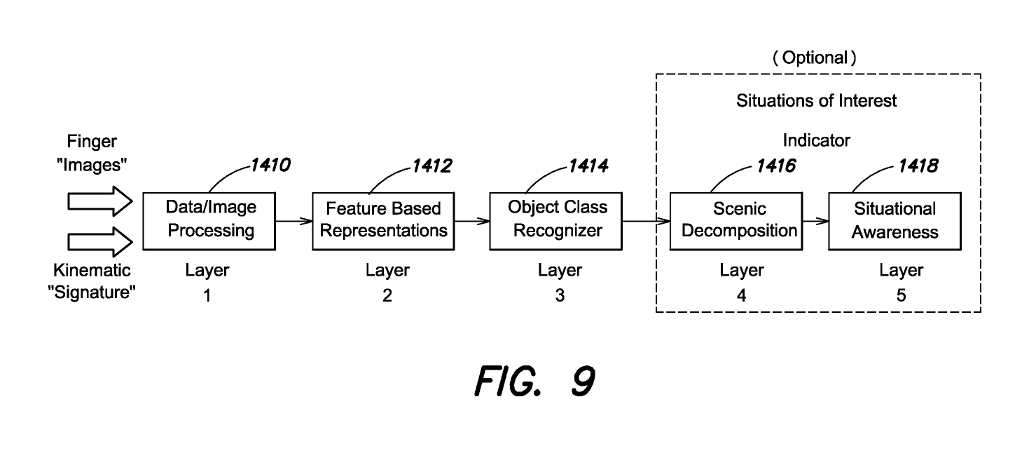

A functional block diagram of a neuromorphic processor which is optionally added to the pen 100 and/or server 320 is shown in FIG. 9. It may have as many as five (5) functional layers. The image and signature processing previously described may be implemented as part of the first three layers. The first 1410 of these layers is a data or results processor. The second layer 1412 is populated with feature based representations of the profile objects, including the finger images and habitual gesture data, and is not unlike a universal dictionary of features. The third layer 1414 is the object class recognizer layer. Optional fourth and fifth layers are concerned with other functions such as inferring the presence of situations of interest.

The design implementation of a layered neuromorphic parallel processor solution addresses the need for a low-power processor that can facilitate massive computational resources necessary for tasks such as user identification or other complex analyses. It is similar to that of a biological neuron with its mixed-mode analog/digital fast neural emulator processor capability where some key features are: Low Size, Weight and Power (SWaP), Low Loss, and Low Installation Complexity and Cost.

One building block of the neuromorphic parallel processor can be a fast neuron emulator. A convolution function is implemented by means of a chirp Fourier transform (CFT) where the matched chirp function is superimposed on the synaptic weights, which are convolved with the incoming data and fed into the dispersive delay line (DDL). If the synaptic weights are matched to the incoming data, then a compressed pulse is seen at the output of the dispersive delay line similar to the action potential in the neural axon. An executive function may control multiple (such as four (4)) fast neuron emulators 1500. The feature based representations are reduced dimensionality single bit complex representations of the original data.

The feature based representations of objects in the second layer 1414 of the neuromorphic parallel processor may be fused to obtain better performance when recognition of individual authorized persons is the objective. Fusion of multimodal kinematic biometric and fingerprint image data can achieve high confidence biometric recognition.

Our preferred approach is based on fusion at the matching stage. In this approach, separate feature extraction is performed on each biometric input image and signature, and a score is independently developed regarding the confidence level that the extracted signature for each modality matches a particular stored (e.g., previously authenticated) biometric record. Then a statistical combination of separate modal scores is done based on the scores and the known degree of correlation between the biometric modalities.

The scores are weighted by the source data quality in both the enrollment and the captured image to give preference to higher quality capture data. If the modes are completely independent (such as habitual gesture and fingerprint image) the correlation is near zero and the mode scores are orthogonal resulting in maximum information in the combined score. If there is a correlation between the modes, the scores are not completely orthogonal, but neither are they coincident, allowing additional confidence information to be extracted from the orthogonal component.

It should be understood that the example embodiments described above may be implemented in many different ways. In some instances, the various “data processors” and pattern recognition described herein may each be implemented by a physical or virtual general purpose computer having a central processor, memory, disk or other mass storage, communication interface(s), input/output (I/O) device(s), and other peripherals. The general purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); storage including magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

Therefore, while this invention has been particularly shown and described with references to example embodiments thereof, it will be understood by those skilled in the art that various changes in form and details may be made therein without departing from the scope of the invention encompassed by the appended claims.

1. A writing apparatus comprising:
a main body;
two or more image sensors disposed on or within the body in an lower portion of the body adjacent an area where the writing apparatus is grasped by a user, the image sensors detecting image data representing partial finger images for undetermined portions of at least two fingers of the user; and
a wireless communication interface for either transmitting the image data to a remote processor, or for receiving image templates representing image data for an authorized user from the remote processor.

2. The apparatus of claim 1 additionally comprising:
a motion sensor, for detecting kinematic data including motion data and/or position data of the writing apparatus; and
wherein the wireless communication interface is further for either transmitting the kinematic data to the remote processor, or for receiving kinematic templates representing kinematic data for an authorized user.

3. The apparatus of claim 2 additionally comprising:
a processor, for comparing the image data against the image templates, and for comparing the kinematic data against the kinematic templates, to determine if the user is an authorized user.

4. The apparatus of claim 2 additionally comprising:
a remote database, for storing the image data and kinematic data; and
wherein the remote processor is for comparing the image data against the image templates, and for comparing the kinematic data against the kinematic templates, to determine if the user is an authorized user.

5. The apparatus of claim 1 wherein the main body is a cylinder having a primary axis and at least one of the image sensors is disposed in a different plane with respect to the main axis than at least one other one of the image sensors.

6. The apparatus of claim 3 wherein the processor further compares the image data against the image templates using a rotation-independent matching algorithm.

7. The apparatus of claim 1 additionally comprising:
a touch sensitive display, for detecting kinematic data indicating motion of the writing apparatus as the user performs an habitual gesture using the writing instrument and the touch sensitive display.

8. A method for authenticating a user of a writing instrument comprising:
detecting two or more partial fingerprint images for undetermined portions of the user's with two or more image sensors disposed within the writing instrument as the user grasps the writing instrument;
transforming the partial fingerprint images to provide rotation-independent partial images;
matching each of the rotation-independent partial images against respective image templates previously detected for one or more authorized users to provide an image match result;
detecting kinematic data indicative of motion of the writing instrument;
matching the kinematic data against respective kinematic templates for one or more authorized users to provide a kinematic match result; and
determining if the user is an authorized user from the image match result and is kinematic match result.

9. The method of claim 8 wherein the image data is received from two or more image sensors disposed in different planes within the writing instrument.

10. The method of claim 8 wherein the kinematic data is received from an accelerometer disposed within the writing instrument.

11. The method of claim 8 wherein the kinematic data is received from a touch sensitive device external to the writing instrument.

12. The method of claim 8 additionally comprising:
sending at least one of the partial image data or kinematic data over a wireless interface to a processor located remotely from the writing instrument.

13. The method of claim 12 wherein the steps of matching the rotation-independent partial images and matching the kinematic data are performed in the processor located remotely from the writing instrument.
